(19) United States
(12) Patent Application Publication
(10) Pub. No.: US 2018/0241702 A1
(43) Pub. Date: Aug. 23, 2018

(54) METHOD AND DEVICE FOR DISPLAYING MESSAGE, AND ELECTRONIC DEVICE

(71) Applicant: BEIJING KINGSOFT INTERNET SECURITY SOFTWARE CO., LTD., BEIJING (CN)

(72) Inventor: Delin LIU, BEIJING (CN)

(21) Appl. No.: 15/754,578

(22) PCT Filed: Sep. 5, 2016
(86) PCT No.: PCT/CN2016/098122

§ 371 Date: Feb. 22, 2018

(30) Foreign Application Priority Data
Sep. 28, 2015 (CN) 201510629774.5

(51) Int. Cl. H04L 12/58

(52) U.S. Cl. CPC H04L 51/043; H04L 51/24; H04L 51/22; H04L 51/08; H04L 51/36

(57) ABSTRACT

Disclosed are a method and a device for displaying a message, and an electronic device. The method is applied to an electronic device. The method includes: obtaining an off-line message conforming to a preset rule from the message received by the electronic device; finding a message prompting strategy corresponding to the off-line message, and performing a message prompting according to the message prompting strategy; and displaying the off-line message in a same display interface according to a preset message display strategy when receiving a message display instruction of a user.

### CROSS-REFERENCE TO RELATED APPLICATIONS

This application is a U.S. national phase application based upon International Application No. PCT/CN2016/098122, filed on Sep. 5, 2016, which is based on and claims a priority to Chinese Patent Application No. 201510629774.5, filed on Sep. 28, 2015, the entire contents of which are incorporated herein by reference.

### FIELD

The present disclosure relates to computer communication technologies, and more particularly, to a method for displaying a message, a device for displaying a message and an electronic device.

### BACKGROUND

With the development of computer network technology, the application of instant messaging (IM for short) software for achieving instant communication on the internet through point-to-point technology is becoming more and more popular. IM software, such as QQ, WeChat, Whatsapp, Facebook, Line and so on, has been accepted by most users and become an indispensable part of daily life and work of the user. The user can communicate with friends, colleagues and classmates though the IM software. For example, by enabling the QQ software, the user can send messages to other QQ friends, and receive messages from other QQ friends in real time, so as to achieve message interactions between QQ friends. After the QQ software is exited, when messages from other QQ friends are received, the messages will be stored in the background, and when the user enables the QQ software again, the background will display stored messages to the user in a QQ software interface to allow the user to browse the messages conveniently. For example, for WeChat software, the user can interact with other WeChat friends after the WeChat software is enabled. When the WeChat software is exited, the user can set whether to receive new messages after the WeChat is exited. By setting that new messages can be received, when a WeChat friend sends new messages after the WeChat software is exited, the user will be prompted that there are new messages through a client screen display interface. When the user chooses to browse the new messages, then the client will enable the WeChat software automatically, and display specific contents of the new messages on the enabled WeChat software interface for the user to browse.

With increasing of users using the client which is installed with the IM software for daily communication, the user has a higher requirement for ease of use and personalized service of the client. Although the IM software in the related art can achieve message interaction independently, for each IM software, the message sent by other clients thorough the IM software can be viewed only when the IM software is enabled, so that it needs to enable the corresponding IM software respectively when views and browses the messages sent by different IM softwares, which causes tedious operating procedures and takes long time to view the message, thus efficiency of viewing message is low. For example, for the user who has installed multiple IM softwares, there may be many messages to be interacted through the corresponding IM softwares. However, after the IM software is exited, in order to receive new messages in real time, it is necessary to enable the corresponding IM software frequently to see whether there are new messages, thereby reducing IM business experience of the user. Furthermore, after the client receives off-line messages from each IM software, the user will be prompted, thereby causing interference to normal work of the user.

### SUMMARY

Accordingly, embodiments of the present disclosure provide a method for displaying a message, a device for displaying a message and an electronic device.

In order to achieve the above object, embodiments of the present disclosure provide technical solutions as follows.

In one aspect, embodiments of the present disclosure provide a method for displaying a message, applied in an electronic device, including obtaining an off-line message conforming to a preset rule from the message received by the electronic device; finding a message prompting strategy corresponding to the off-line message, and performing a message prompting according to the message prompting strategy; and displaying the off-line message in a same display interface according to a preset message display strategy when receiving a message display instruction of a user.

In another aspect, embodiments of the present disclosure provide a device for displaying a message. The device includes a message prompting module and a message displaying module. The message prompting module is configured to obtain an off-line message conforming to a preset rule from the message received by the electronic device, find a message prompting strategy corresponding to the off-line message, and perform a message prompting according to the message prompting strategy. The message displaying module is configured to display the off-line message in a same display interface according to a preset message display strategy when receiving a message display instruction from a user.

Embodiments of the present disclosure provide a computer readable storage medium. The computer readable storage medium is configured to store computer instructions, when a processor of a terminal executes the computer instructions; the terminal performs the method for displaying a message mentioned above.

Embodiments of the present disclosure provide a computer program. The computer program is configured to perform the method for displaying a message when executed by a processor.

### BRIEF DESCRIPTION OF THE DRAWINGS

In order to clearly illustrate technical solutions of embodiments of the present disclosure, a brief description of drawings used in embodiments is given below. Obviously, the drawings in the following descriptions are only part embodiments of the present disclosure, and for those skilled in the art, other drawings can be obtained according to these drawings without creative labor.

FIG. 1 is a flow chart of a method for displaying a message according to an embodiment of the present disclosure.

FIG. 2 is a schematic diagram of a position for performing a message prompting disposed in a display interface according to an embodiment of the present disclosure.

FIG. 3 is a schematic diagram of displaying an off-line message in a same display interface according to a first embodiment of the present disclosure.

FIG. 4 is a schematic diagram of displaying an off-line message in a same display interface according to a second embodiment of the present disclosure.

FIG. 5 is a schematic diagram of displaying an off-line message in a same display interface according a third embodiment of the present disclosure.

FIG. 6 is a block diagram of a device for displaying a message according to an embodiment of the present disclosure.

FIG. 7 is a block diagram of an electronic device according to an embodiment of the present disclosure.

### DETAILED DESCRIPTION

Embodiments of the present disclosure will be described in detail with reference to accompanying drawings.

It should be understood that, embodiments in the following descriptions are only part and not all embodiments of the present disclosure. All other embodiments obtained by those skilled in the art without creative labor based on embodiments of the present disclosure are within the scope of the present disclosure.

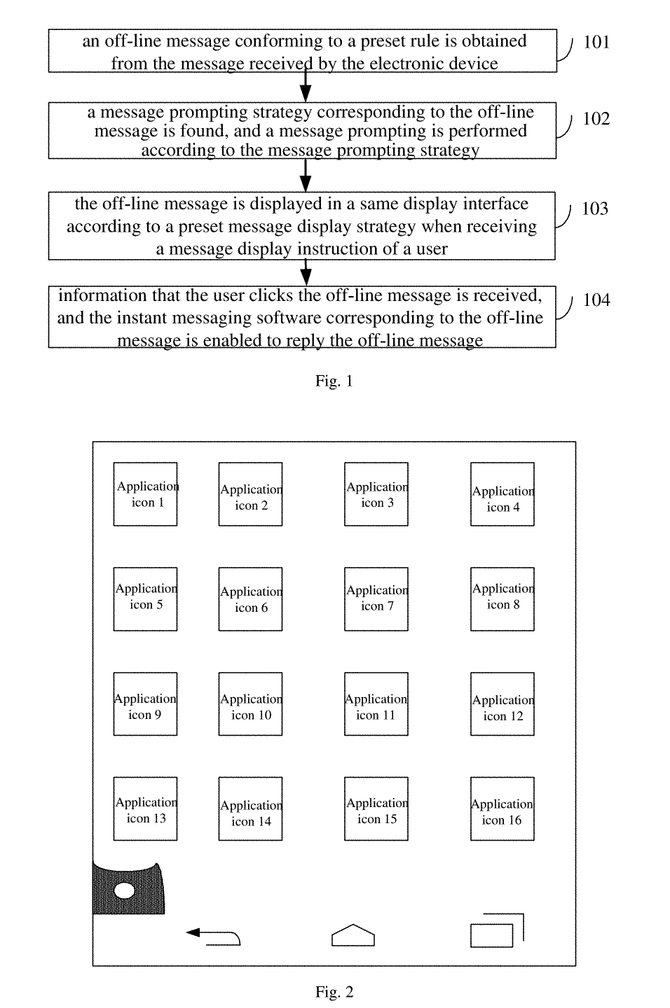

FIG. 1 is a flow chart of a method for displaying a message according to an embodiment of the present disclosure. Referring to FIG. 1, the method is applied in an electronic device and includes the followings.

At block 101, an off-line message conforming to a preset rule is obtained from the message received by the electronic device.

At block 102, a message prompting strategy corresponding to the off-line message is found, and a message prompting is performed according to the message prompting strategy.

At block 101 and block 102, before the off-line message conforming to the preset rule is obtained from the message received by the electronic device, the method further includes setting the message prompting strategy in a message prompting control, and enabling a message prompting function in the message prompting control.

In an alternative embodiment, setting the message prompting strategy in the message prompting control includes enabling the message prompting control, opening a recent page of the message prompting control, and setting the message prompting strategy in the recent page.

When a user actively opens the iSwipe interface for a second time, the message prompting strategy is set in the recent page of the message prompting control, and the message prompting function is enabled.

In an embodiment of the present disclosure, the message prompting strategy includes a name of a software for performing the message prompting, a time period for performing the message prompting and a position for performing the message prompting.

The name of the software for performing the message prompting is a name of the IM software that needs to perform the message prompting after the off-line message is received. In an embodiment of the present disclosure, the name of the IM software for performing the message prompting can be set according to actual needs of the user. For example, it can be set that the name of the IM software that needs to perform the message prompting includes QQ, WeChat, micro-blog, Facebook, etc. In this way, after the user quits the QQ, WeChat, micro-blog, Facebook and other IM software, and when the QQ, WeChat, micro-blog, and Facebook receives a new message, the user can be prompted.

The time period for performing the message prompting can be set according to actual needs of the user. For example, it can be set that the message promoting is performed in real time, that is, the time period is set to be real time. When the IM software corresponding to above IM software name for performing the message prompting receives the off-line message, the user can be prompted. Certainly, in an actual application, in order to reduce interference of new message to the user effectively, the time period can be set to be a fixed time interval, for example, 5 minutes or 1 hour. In the fixed time interval, even a new off-line message is received, the user is not prompted, but the received message is cached until the fixed time interval is completed. When the new message is not received in the fixed time interval, then the next time period (the fixed time interval) is started. In an embodiment of the present disclosure, the fixed time interval may be set at a leisure time period of the user, for example, it can be set that the time interval from 7:00 to 8:30 in the morning is the leisure time period of the user. At 7:00 in the morning, the user is prompted when there is cached message, while in the time period from 7:00 to 8:30 in the morning, the user is prompted in real time once a message is received, while after 8:30 in the morning, the message is cached and the user is not prompted. In this way, interference of the message to the user can be reduced effectively.

Certainly, in the actual application, a message prompting condition can also be set in the message prompting strategy. For example, it can be set that the message prompting is performed in a case that the client is enabled. When the client is not enabled, even if the time interval or the time period is completed, the message prompting is not performed until the client is enabled. Furthermore, the message prompting condition can also be set that the message prompting is performed in an unlocked state of the client, that is, the user is prompted that there is the new message according to the time period for performing the massage prompting only when the client is in the unlocked state.

The position for performing the massage prompting is configured as a position where the message prompting control is in the client display interface (a desktop screen). In an alternative embodiment, the position for performing the massage prompting is located at the position where the corresponding IM software icon is in the client display interface, and the user is prompted that there is the new message in a manner that IM software icon flashes. After the user clicks any one flashing IM software icon, the message received by all IM softwares can be displayed in the display interface.

In another alternative embodiment, in order to improve effectiveness of message prompting, the position for performing the message prompting can be set at a position where a preset prompting icon is. The prompting icon is located at a warped-shape position in a corner of display interface, for example, at a warped-shape position in a lower left corner of the display interface.

FIG. 2 is a schematic diagram of a position for performing a message prompting disposed in a display interface according to an embodiment of the present disclosure. In FIG. 2, there are multiple application icons arranged in the display interface, the message prompting icon (a circle) is set at a warped-shape visible position of the lower left corner of the display interface (a position of the circle in a shadow of FIG. 2). When the message prompting is not performed, the message prompting icon at the warped-shape position remains stationary, and when the message prompting is performed, the message prompting icon at the warped-shape position flashes with an animation. Certainly, in the actual application, the position for performing the message prompting can be set at warped-shape positions of other corners of the display interface or other positions of the display interface.

In an embodiment of the present disclosure, the user can click an enable control button in the recent page, and if there is a prompt indicating a successful enabling, the message prompting function in the message prompting control is enabled.

At block 103, the off-line message is displayed in a same display interface according to a preset message display strategy when receiving a message display instruction from a user.

When the message prompting icon corresponding to the warped-shape visible position of a desktop corner flashes with the animation, it indicates that the user receives a new message. The user can click the flashing message prompting icon to send the message display instruction. In another alternative embodiment, the user can also trigger the message display instruction by clicking any one of the IM software icons that flashes with the animation in the display interface.

In an alternative embodiment, the message display strategy includes a message page setting strategy and a message arranging strategy.

The message page setting strategy is configured to set whether the message is displayed in a way that the display interface is in the warped-shape or in a full display interface. In the strategy for displaying the message in the way that the display interface is in the warped-shape, the display interface can be divided into overlapping two portions by showing a part of the display interface in the warped-shape. In an overlapping portion, the application icon is displayed and the application icon with the new message is marked. In another overlapping portion, the message is displayed according to the message arranging strategy. In an embodiment of the present disclosure, preferably, the message page setting strategy is the strategy for displaying the message in the way that the display interface is in the warped-shape. Certainly, in the actual application, the message can also be displayed in a suspension window or a suspension layer suspended in the display interface.

The message arranging strategy may be explained as follows, in the time period for performing the message prompting, when the messages are only received from a same IM software and when the number of messages is less than a first preset threshold number, the received messages are displayed in chronological order, otherwise, the first preset threshold number of messages are displayed in chronological order, and information of a total number of messages is displayed below the last displayed message; when the messages are received from a plurality of IM softwares, a one-to-one mapping between an IM software and a message entry is set. The message entry includes an icon of the IM software (or the IM software name) and the number of messages corresponding to the message entry. When the number of message entries exceeds a second preset threshold number, the second preset threshold number of message entries are displayed according to the preset message display strategy, and information of a total number of message entries is displayed below the last displayed message entry.

In an alternative embodiment, in order to enhance browsing experience of the user, when the messages are displayed, the animation effect between displayed messages can be set in the message arranging strategy. For example, in chronological order, the animation effect that transparencies of the messages displayed in sequence reduce gradually can be set, that is, the transparency of a previous displayed message is higher than the transparency of a next displayed message.

For multiple IM softwares, the preset message display strategy can be set according to actual needs of the user. For example, the message entries corresponding to Chinese IM softwares can be displayed first, and then the message entries corresponding to English IM softwares are displayed. The message entries can also be displayed in an order of a first letter corresponding to the IM software.

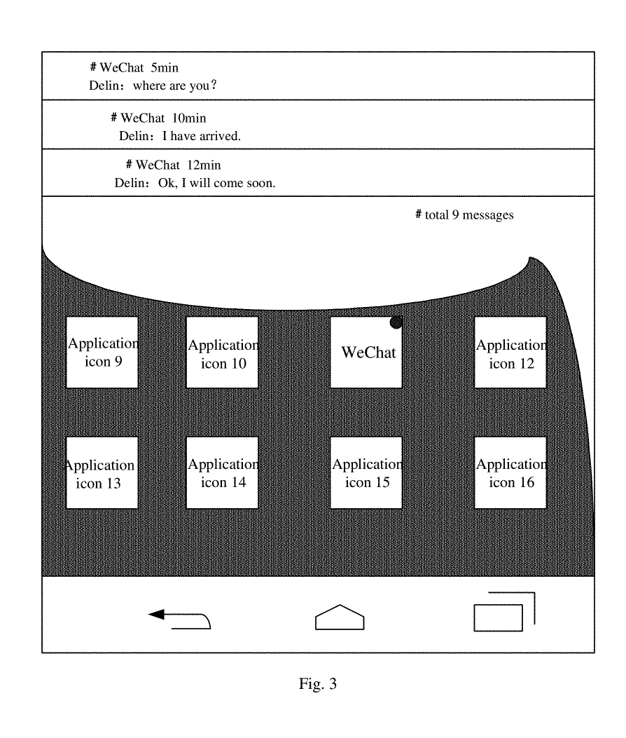

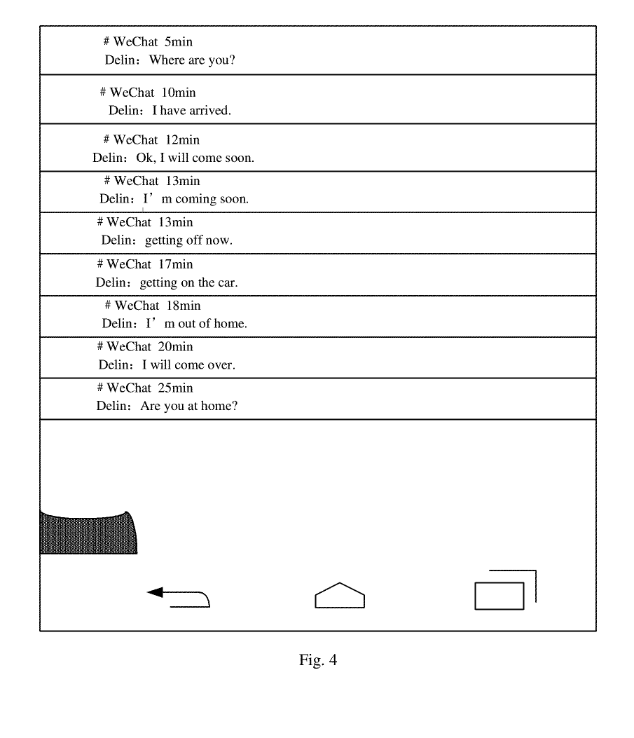

FIG. 3 is a schematic diagram of displaying an off-line message in a same display interface according a first embodiment of the present disclosure. Referring to FIG. 3, after the display interface is divided into two overlapping portions in the way that the display interface is in the warped-shape, the upper of the overlapping portions is used to display the messages, and the lower of the overlapping portions is used to display the IM software icon with the new message, in which the IM software icon with the new message is marked using a black circle. In the time period set for the message prompting, that is, the time period for performing the message prompting, when the messages are only received form WeChat, if the preset threshold number is 3, the number of received messages is 9, i.e., the number of messages is greater than the preset threshold number, 3 messages received latest are displayed in the chronological order from late to early, and the information “total 9 messages” is displayed below the last displayed message. If the user clicks the control corresponding to the information “total 9 messages”, all the messages can be displayed. In an alternative embodiment of the present disclosure, after the user clicks the control corresponding to the information “total 9 messages”, the messages can be displayed sequentially in the overlapping portion for displaying the message in FIG. 3. When there is no enough space in the overlapping portion for displaying the message, a next interface of the overlapping portion can be shown for displaying the messages by sliding the interface. It can also shrink the overlapping portion for displaying the application icon in FIG. 3 to extent the overlapping portion for displaying the message, that is, the warped-shape page is folded, and only a small corner is shown, as illustrated in FIG. 4. FIG. 4 is a schematic diagram of displaying an off-line message in a same display interface according a second embodiment of the present disclosure. After the user browses the messages displayed in FIG. 4, if the user clicks a return control (a first icon in the lower left corner of FIG. 4) or a clear control, the page will be updated and switched back to the interface illustrated in FIG. 2, in this case, the message prompting control in the interface is in a stationary state (non-flashing state). It can be seen from FIG. 4, the warped-shape display interface is similar to a case that a part of the paper is warped, and a specific representation refers to that an appearance of a part of the display interface is different from that of the other part.

Furthermore, when the user clicks the displayed message to reply, the corresponding IM software can be triggered and enabled, and the message can be replied in the display interface of enabled IM software.

In an embodiment of the present disclosure, by obtaining the off-line message received by each software, the obtained off-line messages are arranged without changing specific content and format of each message.

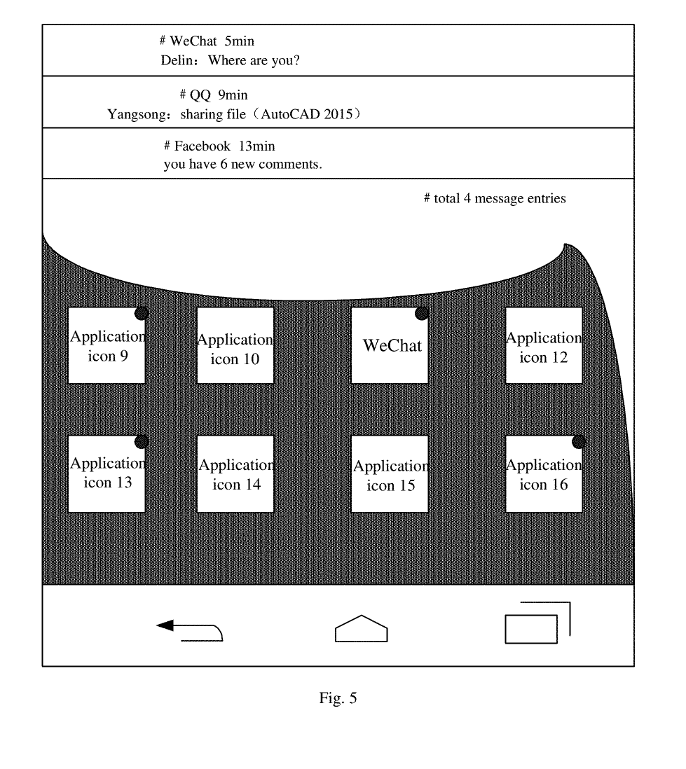

FIG. 5 is a schematic diagram of displaying an off-line message in a same display interface according a third embodiment of the present disclosure. Referring to FIG. 5, the display interface is divided into two overlapping portions in the way that the display interface is in the warped-shape, the upper of the overlapping portions is used to display the message, and the lower of the overlapping portions is used to display the IM software icon with the new message, in which the IM software icon with the new message is marked using a black circle. In an embodiment of the present disclosure, an application icon 9, WeChat, an application icon 13 and an application icon 16 have the black circles, which indicates that these softwares have new received messages. In the time period set for the message prompting, the messages are received from 4 IM softwares, the corresponding number of the message entries is 4, the number of message entries is greater than the second preset threshold number, 3 message entries received latest are displayed in chronological order from late to early, and the information “total 4 message entries” is displayed below the last displayed message entry. If the user clicks the control corresponding to the information “total 4 message entries”, all the messages can be displayed. If the user clicks the message entry corresponding to the IM software, the IM software can be enabled, and all the messages received by the IM software can be displayed in the display interface of the enabled IM software. Certainly, in the actual application, an application icon with a black circle can be clicked to enable the IM software corresponding to the application icon, and all the messages received by the IM software can be displayed in the display interface of the enabled IM software.

In an alternative embodiment, the method further includes an action at block 104.

At block 104, information that the user clicks the off-line message is received, and the IM software corresponding to the off-line message is enabled to reply the off-line message.

In addition, in a case where an amount of message data is large, a network type of the client of the user can be further considered. When the network type is a charged network, the user is prompted to determine whether to download a file corresponding to the message through the charged network when the user clicks the file corresponding to the message for downloading. That is, after the information that the user clicks the off-line message is received, and before the IM software corresponding to the off-line message is enabled to reply the off-line message, the method further includes followings.

It is determined whether there is a file to be downloaded corresponding to the off-line message clicked by the user, if no, the act of enabling the IM software corresponding to the off-line message to reply the off-line message is executed, if yes, a network type of the client is obtained when the file has data greater than a preset data threshold, and the user is prompted to determine whether to download the file through a charged network when the network type of the client is the charged network.

It can be seen from the above that, with the method for displaying the message of the embodiments of the present disclosure, the message prompting is performed on the received off-line message according to the message prompting strategy, and the received off-line message is displayed in the same display interface according to the preset message display strategy after the message display instruction is received. In this way, by providing a platform for displaying the message, messages of all the IM softwares can be viewed simply and quickly on the platform, and it needs not to enable respective software, the messages can be read immediately, and it is possible to process the messages from multiple IM softwares at once, which is simple and fast, thereby saving time and operating procedures of enabling the softwares, and enhancing efficiency of viewing the messages. In addition, the user can determine whether to reply after reading the message. When the message needs to reply, the software can be triggered and enabled automatically by clicking the message. And, the message prompting is performed according to the preset message prompting strategy, thereby avoiding interference with normal work of the user effectively.

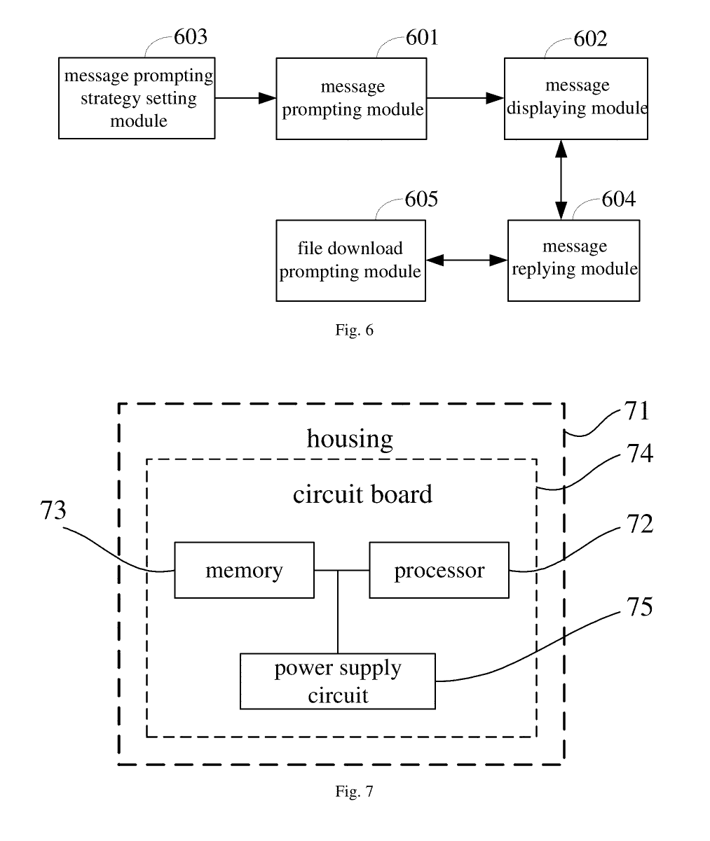

FIG. 6 is a block diagram of a device for displaying a message according to an embodiment of the present disclosure. Referring to FIG. 6, the device includes a message prompting module 601 and a message displaying module 602.

The message prompting module 601 is configured to obtain an off-line message conforming to a preset rule from the message received by the electronic device, find a message prompting strategy corresponding to the off-line message, and perform a message prompting according to the message prompting strategy.

The message displaying module 602 is configured to display the off-line message in a same display interface according to a preset message display strategy when receiving a message display instruction from a user.

In an embodiment of the present disclosure, the message display strategy includes a message page setting strategy and a message arranging strategy.

The message page setting strategy is configured to set whether to display the message in a way that the display interface is in the warped-shape or in a full display interface.

The message arranging strategy may be configured as setting an animation effect between displayed messages, and in the time period for performing the message prompting, when received messages are from a same IM software, and when the number of the received messages is less than a first preset threshold number, displaying the received messages in chronological order, otherwise, displaying the first preset threshold number of messages in chronological order, and displaying information of the number of the received messages below a last displayed message, and when the received messages are from a plurality of IM softwares, setting a one-to-one mapping between an IM software and a message entry, in which, the message entry includes an icon of the IM software (or the IM software name) and the number of messages, when the number of message entries exceeds a second preset threshold number, displaying the second preset threshold number of message entries according to the preset message display strategy, and displaying information of the number of message entries below a last displayed message entry.

In alternative embodiment of the present disclosure, when the message prompting icon corresponding to the warped-shape visible position of a desktop corner flashes with the animation, it indicates that the user receives a new message. The user can click the flashing message prompting icon to send the message display instruction. In another alternative embodiment, the user can also trigger the message display instruction by clicking any one of the IM software icons that flashes with the animation in the display interface.

In an alternative embodiment, the device further includes a message prompting strategy setting module 603. The message prompting strategy setting module 603 is configured to set the message prompting strategy in a message prompting control, and enable a message prompting function in the message prompting control.

In an embodiment of the present disclosure, the message prompting strategy includes a name of a software for performing the message prompting, a time period for performing the message prompting and a position for performing the message prompting. The position for performing the message prompting is disposed at a position where a corresponding IM software icon is in a client display interface, or at a position where a preset prompting icon is. The preset prompting icon is at a warped-shape position in a corner of the client display interface.

In an embodiment of the present disclosure, setting the message prompting strategy in a message prompting control includes enabling the message prompting control, opening a recent page of the message prompting control, and setting the message prompting strategy in the recent page.

In another alternative embodiment, the device further includes a message replying module 604. The message replying module 604 is configured to receive information that the user clicks the off-line message, and enable an IM software corresponding to the off-line message to reply the off-line message.

In another alternative embodiment, the device further includes a file download prompting module 605. The file download prompting module 605 is configured to determine whether there is a file to be downloaded corresponding to the off-line message clicked by the user, if no, enable the IM software corresponding to the off-line message to reply the off-line message, if yes, obtain a client network type when the file to be downloaded is greater than a preset data threshold, and prompt the user to determine whether to download the file to be downloaded through a charged network when the client network type is the charged network.

Embodiments of the present disclosure provide an electronic device, and the electronic device includes the device described in any of the above embodiments.

FIG. 7 is a block diagram of an electronic device according to an embodiment of the present disclosure, which can implement the acts of the embodiments illustrated in FIGS. 1-6 of the present disclosure. As illustrated in FIG. 7, the electronic device includes a housing 71, a processor 72, a memory 73, a circuit board 74 and a power supply circuit 75. The circuit board 74 is disposed in a space enclosed by the housing 71. The processor 72 and the memory 73 are positioned on the circuit board 74. The power supply circuit 75 is configured to supply power for respective circuits or components of the electronic device. The memory 73 is configured to store executable program codes. The processor 72 is configured to execute a program corresponding to the executable program codes by reading the executable program codes stored in the memory 73, to perform following operations: obtaining an off-line message conforming to a preset rule from the message received by the electronic device; finding a message prompting strategy corresponding to the off-line message, and performing a message prompting according to the message prompting strategy; and displaying the off-line message in a same display interface according to a preset message display strategy when receiving a message display instruction of a user.

Regarding the detailed execution of the processor 72 for performing the above acts, and acts which are further executed by the processor 72 by running the executable program codes, reference can be made to the description of the embodiments illustrated in FIGS. 1-6 of the present disclosure, which will not be described herein.

The electronic device is present in a variety of forms, includes but is not limited to the follows.

(1) A mobile communication device, having a mobile communication function, and aiming to provide the voice, data communication. This kind of terminals includes smart phones (such as iPhone), multimedia phones, functional phones, and low-end mobile phones.

(2) An ultra-mobile personal computer device, belonging to personal computers, having functions of computing and processing, and generally having mobile internet access features. This kind of terminals includes PDAs, MIDs and UMPC devices, such as iPad.

(3) A portable entertainment device. The kind of device can display and play multimedia contents. This kind of devices includes audio, video players (such as iPod), handheld game consoles, e-books, and smart toys and portable on-board navigation devices.

(4) A server, the device that provides computing service. The server includes a processor, a hard disk, a memory and a system bus. The server is similar to a common computer architecture. However, since it needs to provide high reliable service, the processing capacity, stability, reliability, safety, scalability, manageability and other requirements are higher.

(5) Other electronic devices with data exchange functions.

In addition, embodiments of the present disclosure provide a storage medium. The storage medium is configured to store an application program. The application program is configured to execute the method for displaying the message described in embodiments of the present disclosure at running time. The method for displaying the message described in embodiments of the present disclosure includes following operations: obtaining an off-line message conforming to a preset rule from the message received by the electronic device; finding a message prompting strategy corresponding to the off-line message, and performing a message prompting according to the message prompting strategy; and displaying the off-line message in a same display interface according to a preset message display strategy when receiving a message display instruction of a user.

In addition, embodiments of the present disclosure provide an application program. The application program is configured to execute the method for displaying the message described in embodiments of the present disclosure at running time. The method for displaying the message described in embodiments of the present disclosure includes following operations: obtaining an off-line message conforming to a preset rule from the message received by the electronic device; finding a message prompting strategy corresponding to the off-line message, and performing a message prompting according to the message prompting strategy; and displaying the off-line message in a same display interface according to a preset message display strategy when receiving a message display instruction of a user.

It would be understood by those skilled in the art that all or a part of the steps carried by the method in the above-described embodiments may be completed by relevant hardware instructed by a program. The program may be stored in a computer readable storage medium. When the program is executed, one or a combination of the steps of the method in the above-described embodiments may be completed. The storage medium may be a magnetic disk, an optical disk, a read-only memory (ROM), a random access memory (RAM), or the like.

Embodiments described above are only specific embodiments of the present disclosure, but the scope of the present disclosure is not limited thereto, any variants and modifications that may be apparent to those skilled in the art are within the scope of the present disclosure. Therefore, the scope of the present disclosure is defined in the claims.

1. A method for displaying a message, applied in an electronic device, comprising:
obtaining an off-line message conforming to a preset rule from the message received by the electronic device;
finding a message prompting strategy corresponding to the off-line message, and performing a message prompting according to the message prompting strategy; and
displaying the off-line message in a same display interface according to a preset message display strategy when receiving a message display instruction of a user.

2. The method according to claim 1, before obtaining the off-line message conforming to the preset rule from the message received by the electronic device, further comprising:
setting the message prompting strategy in a message prompting control, and enabling a message prompting function in the message prompting control.

3. The method according to claim 2, wherein setting the message prompting strategy in the message prompting control comprises:
enabling the message prompting control, opening a recent page of the message prompting control, and setting the message prompting strategy in the recent page.

4. The method according to claim 2, wherein the message prompting strategy comprises:
a name of a software for performing the message prompting, a time period for performing the message prompting and a position for performing the message prompting; wherein,
the position for performing the message prompting is located at a position where a corresponding instant messaging software icon is in a client display interface, or at a position where a preset prompting icon is, wherein the preset prompting icon is at a warped-shape position in a corner of the client display interface.

5. The method according to claim 1, wherein the message display strategy comprises a message page setting strategy and a message arranging strategy, wherein,
the message page setting strategy comprises a message page setting strategy for displaying the message in a way that the display interface is in the warped-shape and a message page setting strategy for displaying the message in a full display interface;
the message arranging strategy is configured as:
setting an animation effect between displayed messages; and,
in the time period for performing the message prompting,
when received messages are from a single instant messaging software, and when a total number of the received messages is less than a first preset threshold number, displaying the received messages in chronological order, otherwise, displaying the first preset threshold number of messages in chronological order, and displaying information of the total number of the received messages below a last displayed message;
when the received messages are from a plurality of instant messaging softwares, setting a one-to-one mapping between an instant messaging software and a message entry, wherein the message entry comprises an icon of the instant messaging software and a number of messages, when a total number of message entries exceeds a second preset threshold number, displaying the second preset threshold number of message entries according to the preset message display strategy, and displaying information of the total number of the message entries below a last displayed message entry.

6. The method according to claim 1, further comprising:
receiving information that the user clicks the off-line message, and enabling an instant messaging software corresponding to the off-line message to reply the off-line message.

7. The method according to claim 6, after receiving information that the user clicks the off-line message, and before enabling the instant messaging software corresponding to the off-line message to reply the off-line message, further comprising:
determining whether there is a file to be downloaded corresponding to the off-line message clicked by the user, if no, enabling the instant messaging software corresponding to the off-line message to reply the off-line message; if yes, obtaining a client network type when the file to be downloaded is greater than a preset data threshold, and prompting the user to determine whether to download the file to be downloaded through a charged network when the client network type is the charged network.

8. A device for displaying a message, wherein the device comprises a non-transitory computer-readable medium comprising computer-executable instructions stored thereon, and an instruction execution system which is configured by the computer-executable instructions to implement at least one of:
a message prompting module, configured to obtain an off-line message conforming to a preset rule from the message received by the electronic device, find a message prompting strategy corresponding to the off-line message, and perform a message prompting according to the message prompting strategy; and
a message displaying module, configured to display the off-line message in a same display interface according to a preset message display strategy when receiving a message display instruction from a user.

9. The device according to claim 8, wherein the instruction execution system is further configured by the computer-executable instructions to implement:
a message prompting strategy setting module, configured to set the message prompting strategy in a message prompting control, and enable a message prompting function in the message prompting control.

10. The device according to claim 9, wherein setting the message prompting strategy in the message prompting control comprises:
enabling the message prompting control, opening a recent page of the message prompting control, and setting the message prompting strategy in the recent page.

11. The device according to claim 8, wherein the message prompting strategy comprises:
a name of a software for performing the message prompting, a time period for performing the message prompting and a position for performing the message prompting; wherein,
the position for performing the message prompting is located at a position where a corresponding instant messaging software icon is in a client display interface, or at a position where a preset prompting icon is, wherein the preset prompting icon is at a warped-shape position in a corner of the client display interface.

12. The device according to claim 8, wherein the message display strategy comprises a message page setting strategy and a message arranging strategy, wherein,
the message page setting strategy comprises a message page setting strategy for displaying the message in a way that the display interface is in the warped-shape and a message page setting strategy for displaying the message in a full display interface;
the message arranging strategy is configured as:
setting an animation effect between displayed messages; and
in the time period for performing the message prompting,
when received messages are from a single instant messaging software, and when a total number of the received messages is less than a first preset threshold number, displaying the received messages in chronological order, otherwise, displaying the first preset threshold number of messages in chronological order, and displaying information of the total number of the received messages below a last displayed message;
when the received messages are from a plurality of instant messaging softwares, setting a one-to-one mapping between an instant messaging software and a message entry, wherein the message entry comprises an icon of the instant messaging software and a number of messages, when a total number of message entries exceeds a second preset threshold number, displaying the second preset threshold number of message entries according to the preset message display strategy, and displaying information of the total number of the message entries below a last displayed message entry.

13. The device according to claim 8, wherein the instruction execution system is further configured by the computer-executable instructions to implement:
a message replying module, configured to receive information that the user clicks the off-line message, and enable an instant messaging software corresponding to the off-line message to reply the off-line message.

14. The device according to claim 13, wherein the instruction execution system is further configured by the computer-executable instructions to implement:
a file download prompting module, configured to determine whether there is a file to be downloaded corresponding to the off-line message clicked by the user, if no, enable the instant messaging software corresponding to the off-line message to reply the off-line message; if yes, obtain a client network type when the file to be downloaded is greater than a preset data threshold, and prompt the user to determine whether to download the file to be downloaded through a charged network when the client network type is the charged network.

15. An electronic device, comprising: a housing, a processor, a memory, a circuit board and a power supply circuit, wherein,
the circuit board is disposed in a space enclosed by the housing,
the processor and memory are positioned on the circuit board;
the power supply circuit is configured to provide power for respective circuits or components of the electronic device;
the memory is configured to store executable program codes;
the processor is configured to execute a program corresponding to the executable program codes by reading the executable program codes stored in the memory, to perform following operations:
obtaining an off-line message conforming to a preset rule from the message received by the electronic device;
finding a message prompting strategy corresponding to the off-line message, and performing a message prompting according to the message prompting strategy; and
displaying the off-line message in a same display interface according to a preset message display strategy when receiving a message display instruction of a user.

16.-17. (canceled)

18. The method according to claim 2, wherein the message display strategy comprises a message page setting strategy and a message arranging strategy, wherein,
the message page setting strategy comprises a message page setting strategy for displaying the message in a way that the display interface is in the warped-shape and a message page setting strategy for displaying the message in a full display interface;
the message arranging strategy is configured as:
setting an animation effect between displayed messages; and,
in the time period for performing the message prompting,
when received messages are from a single instant messaging software, and when a total number of the received messages is less than a first preset threshold number, displaying the received messages in chronological order, otherwise, displaying the first preset threshold number of messages in chronological order, and displaying information of the total number of the received messages below a last displayed message;
when the received messages are from a plurality of instant messaging softwares, setting a one-to-one mapping between an instant messaging software and a message entry, wherein the message entry comprises an icon of the instant messaging software and a number of messages, when a total number of message entries exceeds a second preset threshold number, displaying the second preset threshold number of message entries according to the preset message display strategy, and displaying information of the total number of the message entries below a last displayed message entry.

19. The method according to claim 3, wherein the message display strategy comprises a message page setting strategy and a message arranging strategy, wherein,
the message page setting strategy comprises a message page setting strategy for displaying the message in a way that the display interface is in the warped-shape and a message page setting strategy for displaying the message in a full display interface;
the message arranging strategy is configured as:
setting an animation effect between displayed messages; and,
in the time period for performing the message prompting,
when received messages are from a single instant messaging software, and when a total number of the received messages is less than a first preset threshold number, displaying the received messages in chronological order, otherwise, displaying the first preset threshold number of messages in chronological order, and displaying information of the total number of the received messages below a last displayed message;
when the received messages are from a plurality of instant messaging softwares, setting a one-to-one mapping between an instant messaging software and a message entry, wherein the message entry comprises an icon of the instant messaging software and a number of messages, when a total number of message entries exceeds a second preset threshold number, displaying the second preset threshold number of message entries according to the preset message display strategy, and displaying information of the total number of the message entries below a last displayed message entry.

20. The method according to claim 4, wherein the message display strategy comprises a message page setting strategy and a message arranging strategy, wherein,
the message page setting strategy comprises a message page setting strategy for displaying the message in a way that the display interface is in the warped-shape and a message page setting strategy for displaying the message in a full display interface;
the message arranging strategy is configured as:
setting an animation effect between displayed messages; and,
in the time period for performing the message prompting,
when received messages are from a single instant messaging software, and when a total number of the received messages is less than a first preset threshold number, displaying the received messages in chronological order, otherwise, displaying the first preset threshold number of messages in chronological order, and displaying information of the total number of the received messages below a last displayed message;
when the received messages are from a plurality of instant messaging softwares, setting a one-to-one mapping between an instant messaging software and a message entry, wherein the message entry comprises an icon of the instant messaging software and a number of messages, when a total number of message entries exceeds a second preset threshold number, displaying the second preset threshold number of message entries according to the preset message display strategy, and displaying information of the total number of the message entries below a last displayed message entry.

21. The device according to claim 9, wherein the message display strategy comprises a message page setting strategy and a message arranging strategy, wherein,
the message page setting strategy comprises a message page setting strategy for displaying the message in a way that the display interface is in the warped-shape and a message page setting strategy for displaying the message in a full display interface;
the message arranging strategy is configured as:
setting an animation effect between displayed messages; and
in the time period for performing the message prompting,
when received messages are from a single instant messaging software, and when a total number of the received messages is less than a first preset threshold number, displaying the received messages in chronological order, otherwise, displaying the first preset threshold number of messages in chronological order, and displaying information of the total number of the received messages below a last displayed message;
when the received messages are from a plurality of instant messaging softwares, setting a one-to-one mapping between an instant messaging software and a message entry, wherein the message entry comprises an icon of the instant messaging software and a number of messages, when a total number of message entries exceeds a second preset threshold number, displaying the second preset threshold number of message entries according to the preset message display strategy, and displaying information of the total number of the message entries below a last displayed message entry.

22. The device according to claim 10, wherein the message display strategy comprises a message page setting strategy and a message arranging strategy, wherein,
the message page setting strategy comprises a message page setting strategy for displaying the message in a way that the display interface is in the warped-shape and a message page setting strategy for displaying the message in a full display interface;
the message arranging strategy is configured as:
setting an animation effect between displayed messages; and
in the time period for performing the message prompting,
when received messages are from a single instant messaging software, and when a total number of the received messages is less than a first preset threshold number, displaying the received messages in chronological order, otherwise, displaying the first preset threshold number of messages in chronological order, and displaying information of the total number of the received messages below a last displayed message;
when the received messages are from a plurality of instant messaging softwares, setting a one-to-one mapping between an instant messaging software and a message entry, wherein the message entry comprises an icon of the instant messaging software and a number of messages, when a total number of message entries exceeds a second preset threshold number, displaying the second preset threshold number of message entries according to the preset message display strategy, and displaying information of the total number of the message entries below a last displayed message entry.
